(19) United States
(12) Patent Application Publication
(10) Pub. No.: US 2010/0043625 A1
(43) Pub. Date: Feb. 25, 2010

(54) MUSICAL COMPOSITION SYSTEM AND METHOD OF CONTROLLING A GENERATION OF A MUSICAL COMPOSITION

(75) Inventors: Jurjen Lippold Van Geenen, Eindhoven (NL); Ramon Antoine Wiro Clout, Eindhoven (NL); Fabio Vignoli, Eindhoven (NL)

Correspondence Address: PHILIPS INTELLECTUAL PROPERTY & STANDARDS, P.O. BOX 3001, BRIARCLIFF MANOR, NY, 10510, US

(73) Assignee: KONINKLIJKE PHILIPS ELECTRONICS N.V., EINDHOVEN (NL)

(21) Appl. No.: 12/518,127

(22) PCT Filed: Dec. 6, 2007
(86) PCT No.: PCT/IB07/54950

§ 371 Date: Jun. 8, 2009

(30) Foreign Application Priority Data
Dec. 12, 2006 (EP) 06125856.2

(51) Int. Cl. G10H 1/00

(52) U.S. Cl. 84/600

(57) ABSTRACT

A musical composition system, includes a plurality of tokens (5-7) of visibly distinct types, each representing aspects of at least a fragment of a musical composition, wherein the tokens are configured for placement by at least one user in a spatial configuration; a system for determining respective locations and types of an assembly of tokens (5-7) placed in a spatial configuration by the user(s); a system (13-16;44-46) for translating a spatial ordering of the tokens (5-7) in the spatial configuration into a temporal ordering; a system (13,18,40;44-46) for translating the types of the tokens (5-7) into respective aspects of at least a fragment of a musical composition; and a system (13,18-20;44-46) for generating at least one signal representing a synthesis of the respective aspects of fragments of a musical composition in accordance with the temporal ordering, the signals being suitable for audible reproduction. It is arranged to detect or prevent at least an attempted placement of a token of a certain type at a position in the spatial ordering violating any of at least one constraint associated with the certain type.

### FIELD OF THE INVENTION

The invention relates to a method of controlling a generation of a musical composition, a system for controlling a generation of a musical composition, and a computer program.

### BACKGROUND OF THE INVENTION

Respective examples of such a system and method are known from U.S. Pat. No. 6,525,252. This publication discloses a device for composing and arranging music, comprising a sensor device, a plurality of blocks and playback means. The sensor device has a plurality of receiving positions, arranged in a two-dimensional array, of which one dimension represents a temporal domain of the music. Each of the plurality of blocks is suitable for being releasably arranged at each of the receiving positions. Each of the blocks belongs to one of a plurality of sub-populations of blocks and has features detectable by detecting means for detecting to which of the plurality of sub-populations of blocks a block arranged at a receiving position belongs as well as the position of the receiving position and for producing an output accordingly. Each block represents a predetermined musical feature, the representation being dependent on the sub-population to which the block belongs, as well as the position of the block on the sensor device. Blocks belonging to the different sub-populations are distinguishable from each other by visible characteristics. The pre-determined musical feature may be a single note, a beat or a certain musical phrase being played by a certain instrument of any other suitable musical feature.

A problem of the known device is that a user who is starting to learn composition will generate inharmonious compositions, detect this only when the music is played, and have to start positioning the blocks again. The result is that inefficient use is made of the existing device, and that music that is difficult for the device to synthesise and play back may be generated.

### SUMMARY OF THE INVENTION

It is an object of the invention to provide a more efficient system, method and computer program of the types mentioned in the opening paragraph.

This object is achieved by the method of controlling a generation of a musical composition, including

determining respective locations and types of an assembly of tokens placed in a spatial configuration by the user(s), the tokens being of visibly distinct types, each representing aspects of at least a fragment of a musical composition, wherein the tokens are configured for placement by at least one user in a spatial configuration;

translating a spatial ordering of the tokens in the spatial configuration into a temporal ordering;

translating the types of the tokens into respective aspects of at least a fragment of a musical composition using a database relating token types to aspects of at least a fragment of a musical composition;

generating at least one signal representing a synthesis of the respective aspects of fragments of a musical composition in accordance with the temporal ordering, the signals being suitable for audible reproduction, and

detecting or preventing at least an attempted placement of a token of a certain type at a position in the spatial ordering violating any of at least one constraint associated with the certain type.

An aspect of a fragment of a musical composition means a particular component or feature of the fragment, for example one of a plurality of voices or a characteristic such as the tempo or style of performance.

By detecting or preventing at least an attempted placement of a token, based on its type and position in the spatial ordering, placements made in error by the user can be detected before the signal representing the synthesis of the respective aspects of fragments of a musical composition in accordance with the temporal ordering is generated. This makes the method more efficient, because attempts to generate difficult or impossible syntheses of aspects of musical fragments can be avoided, as can repeated executions of the method occasioned by a user attempting to generate a correct composition.

An embodiment includes detecting or preventing at least an attempted placement of each token of a certain type at a position in the spatial ordering violating any of at least one constraint associated with the certain type, as it is placed in the spatial configuration by the user(s).

This prevents use of the system for determining a spatial ordering on a spatial configuration that would result in a nonsensical composition. It solves the problem that the assembly of tokens may have been placed in a spatial configuration that is difficult to analyse in its entirety.

An embodiment, wherein the tokens are configured to be placed in two dimensions and further configured to be placed such as to overlap in the two dimensions, includes determining the tokens' respective positions in one of the two dimensions to translate the spatial ordering into the temporal ordering.

An effect is that two of three dimensions are available to indicate simultaneity and to allow one block to modify the significance of the other. Thus, it solves the problem of providing a high granularity and means for indicating both aspects of a single voice and contemporaneous voice fragments.

In an embodiment, translating the types of tokens into respective aspects of at least a fragment of a musical composition includes selecting one of a plurality of aspects in dependence also on the location of a token in the spatial configuration.

This embodiment addresses the need to prevent very many kinds of wrong placement of tokens. Instead of preventing or detecting an attempted placement of a token of a particular type, the aspect that it represents is modified in dependence on its location in the spatial configuration. An added advantage is that the number of types of tokens can be kept low, because one token can mean several things, depending on the context in which it is placed.

In an embodiment, translating the types of tokens into respective aspects of at least a fragment of a musical composition includes selecting one of a plurality of aspects in dependence also on a user input, for example prompted to be provided on determination of the token's type and position.

This embodiment further addresses the need to have many different visible types of blocks, and also represents an efficient way of dealing with easily resolvable “wrong” combinations of tokens. In this embodiment, the user is called upon to realise a harmonious match of aspects of musical fragments.

In an embodiment, for at least one type of token, only the types of tokens placed immediately adjacent at least one other token are translated into respective aspects of at least a fragment of a musical composition.

This embodiment has the effect of preventing the user(s) from placing tokens in isolation. Thus, a token's type can always be checked against those of its neighbours for compatibility. A further effect is that, for tokens that represent aspects modifying other aspects, the aspects to be modified can be determined more easily.

An embodiment includes providing pairs of tokens of associated types, visibly distinct from tokens of other types and both representing an aspect of a fragment of a musical composition, wherein, at least upon placement by the user(s), a first represents a commencement of the fragment and a second represents a termination of a fragment, translating a distance between the first and second token of a pair in the spatial configuration to an interval of time and extending a translation of the type(s) of the pair of tokens into an aspect of a fragment of a musical composition to the interval of time when generating the signal(s).

An effect of this embodiment is that the position and location of fewer tokens need be determined, since a pair of tokens is sufficient to represent an aspect of a fragment of relatively long duration, or even the entire composition. At the same time, flexibility is given, since global changes, for instance tempo changes or key changes, within a single composition can be indicated efficiently.

An embodiment includes generating configuration data encoding the locations and types of at least one of the tokens placed in a spatial configuration by the user(s), comparing the data with at least one set of reference data, and providing on an output device an indication of the presence or absence of a match between the spatial configuration and at least a part of a configuration represented by the set(s) of reference data.

An effect is that a system employing this embodiment of the method is suitable for teaching users to reproduce compositions.

According to another aspect, the system according to the invention is provided. The musical composition system includes

a system for determining respective locations and types of an assembly of tokens placed in a spatial configuration by the user(s), the tokens being of visibly distinct types, each representing aspects of at least a fragment of a musical composition, wherein the tokens are configured for placement by at least one user in a spatial configuration;

a system for translating a spatial ordering of the tokens in the spatial configuration into a temporal ordering;

a system for translating the types of the tokens into respective aspects of at least a fragment of a musical composition; and

a system for generating at least one signal representing a synthesis of the respective aspects of fragments of a musical composition in accordance with the temporal ordering, the signals being suitable for audible reproduction,

the system being arranged to detect or prevent at least an attempted placement of a token of a certain type at a position in the spatial ordering violating any of at least one constraint associated with the certain type.

Because the at least one constraint associated with the certain type may represent rules of composition, or rules related to a target composition to be generated by the user, it is possible to detect tokens positioned so as to cause the wrong composition to be created. Because the system detects or prevents at least an attempted placement of a token, based on its type and position in the spatial ordering, placements made in error by the user are detected before the signal representing the synthesis of the respective aspects of fragments of a musical composition in accordance with the temporal ordering is generated. This makes the system more efficient. It prevents repeated use, characteristic of a trial and error approach by the user, of the system. It avoids spatial configurations representing compositions that are difficult or impossible to synthesise by an automatic system, which also increases the efficiency with which the system can be used.

In an embodiment, the tokens are configured to allow engagement of at least a section of a side part of a token of a certain type with at least a section of a side part of only a token of any one of fewer than all other types.

Thus, a simple and effective way of preventing the juxtaposition of tokens of incompatible types is provided. The result is that aspects of fragments of musical compositions that are incompatible when present simultaneously or in succession in a musical composition are absent from the at least one signal suitable for audible reproduction.

An embodiment includes an at least one-dimensional playing space, configured to accommodate tokens to be placed in the spatial configuration, wherein the system for determining the respective locations of the assembly of tokens is arranged to determine co-ordinates of the tokens relative to the at least one-dimensional playing space.

An effect is that a relatively easy and inexpensive way of realising a means of determining the spatial ordering of the tokens is provided. It is not necessary only to detect positions of tokens relative to each other, which might require intelligence—or, in the case of tokens comprising tangible objects, an active sensor component—in each token.

In a variant, the playing space includes one of a plurality of differently configured structures at each of a plurality of positions defined to accept a token and wherein the tokens are configured only to allow engagement with fewer than all of the differently configured structures.

Thus, an effective and clear way is provided of preventing the placement of tokens of a particular type at a position within the total composition that is incompatible with its type. As a consequence, certain aspects of fragments will not be present in the signal(s) for audible reproduction at a nonsensical point in the musical composition. For example, an aspect of a finale can be prevented from being present at the start of a piece.

In an embodiment, the tokens comprise respective tangible objects.

In such an implementation, the tokens are easily visible. The use of such an embodiment is very intuitive.

An embodiment includes a computer for generating representations of at least the tokens placed in the spatial configuration on a visual display unit.

An effect is that the types of tokens can be re-configured or customised relatively easily, such that they represent a different aspect of a musical fragment. For example, the same shape or colour of token can have one meaning in the context of the generation of a pop song and another in the context of the generation of a classical symphony.

An embodiment of the system is configured to carry out a method according to the invention.

According to another aspect, the computer program according to the invention includes a set of instructions capable, when incorporated in a machine readable medium, of causing a system having information processing capabilities and including a plurality of tokens of visibly distinct types, configured for placement by at least one user in a spatial configuration and a system for determining respective locations and types of an assembly of tokens placed in a spatial configuration by the user(s) to constitute a system according to the invention or to perform a method according to the invention.

### BRIEF DESCRIPTION OF THE DRAWINGS

The invention will now be explained in further detail with reference to the accompanying drawings, in which:

FIG. 1 is a schematic top view of a first embodiment of a musical composition system;

FIG. 2 is a schematic cross-sectional view of the first embodiment of the musical composition system;

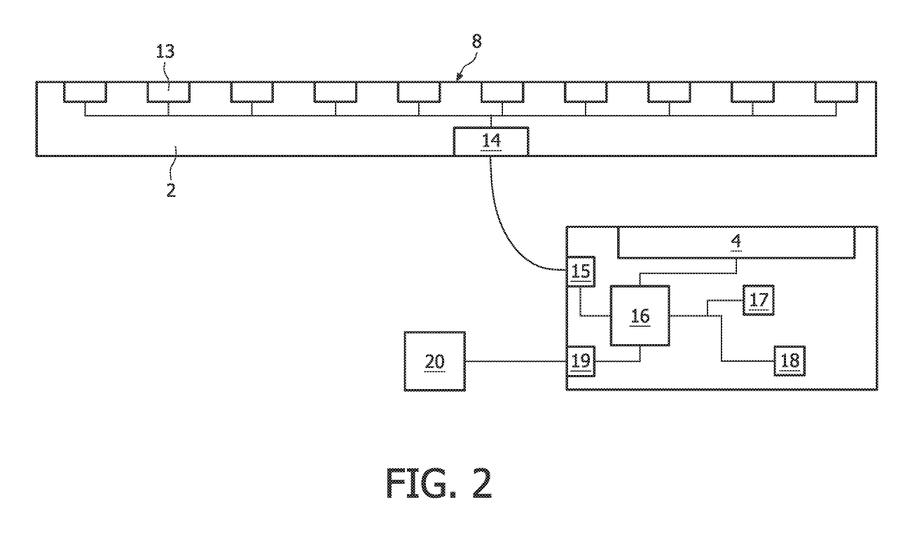

FIG. 3 is a flow chart giving an outline of a method of generating a musical composition;

FIG. 4 is a flow chart giving details of a step in a method of generating a musical composition; and

FIG. 5 is a block diagram of a second embodiment of a musical composition system.

### DETAILED DESCRIPTION OF EMBODIMENTS

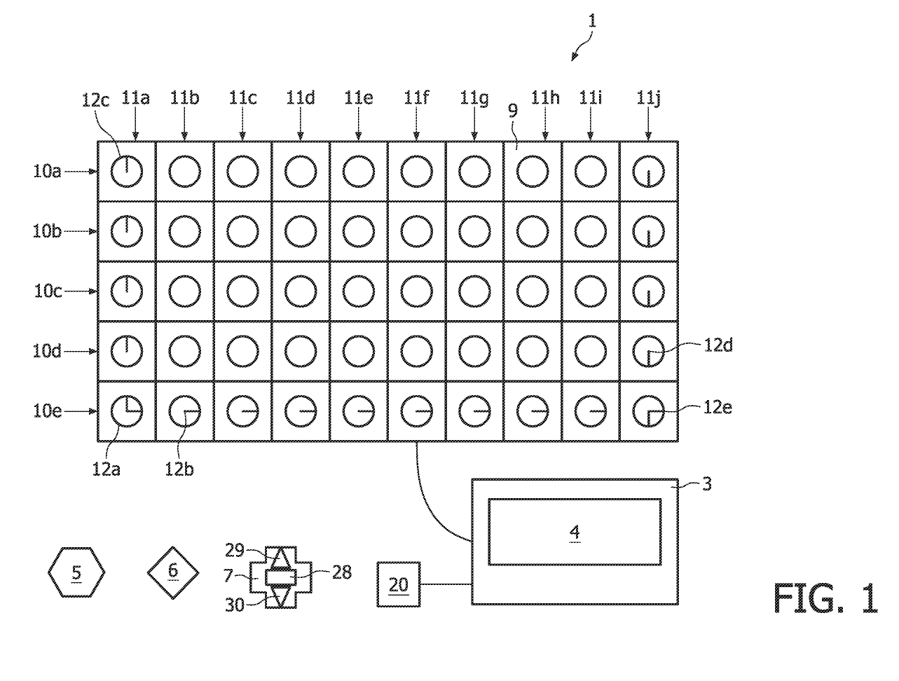

A first musical composition system 1 includes a game board 2, a control unit 3 including a visual display unit 4, and a plurality of tokens 5-7, of which three representative examples are illustrated in FIG. 1.

The tokens 5-7 are of different respective types. A token 5 of a first type is visibly distinct from tokens 6,7 of a second and third type, respectively. In FIG. 1, visible distinctiveness is acquired by the shape of the outline of a token. In other embodiments, tokens may be distinguished also or alternatively by their colour, surface patterning or roughness, etc. In yet another embodiment, their type is printed on them. There are generally several tokens of any particular type.

Each token 5-7 represents an aspect of at least a fragment of a musical composition. An aspect is a particular component or feature of the fragment. Thus, a token may represent a single note or sequence of notes. It may represent a particular instrument or voice, or it may represent a particular rhythmic sequence, tempo, loudness, etc.

The tokens 5-7 are configured for placement by a user in a spatial configuration on a playing surface 8 of the game board 2. The playing surface 8 comprises a number of fields 9, arranged in rows 10a-10e and columns 11a-11j. The columns determine a spatial ordering, which is translated into a temporal ordering by the control unit 3. That is to say that a first column 11a represents a first time interval of the composition and that the time advances by a certain time interval with each column. The time interval may be an absolute time interval or a relative time interval. For example, each column 11 may represent a bar, a beat or a note of a particular duration, depending on the chosen granularity.

It is observed that the fact that the tokens 5-7 are configured for placement on the playing surface 8 does not imply that they are each sized to occupy only one field 9. In alternative embodiments, each token may be larger than one field. The tokens need not be rectangular. In an example, at least one type of token is L-shaped, occupying a first field and a neighbouring field in the same row as well as a neighbouring field in the same column as the first field.

In the illustrated embodiment, all tokens in one column 11 are translated to simultaneously occurring aspects of a fragment of the composition. In another embodiment, both tokens in one column 11 and stacks of tokens indicate simultaneity. In yet another embodiment, there is only a single row, or line, and tokens are stacked one atop the other to indicate simultaneity. The use of an additional dimension allows one to use stacking to signify something else, for example to allow one token to modify the translation of the type of another. Of course, in a variant of the illustrated embodiment, stacking in one row would be used to indicate simultaneity of voices or instruments, with additional rows being used to add tokens modifying the way the voices or instruments sound when reproduced. In another embodiment, rows 10 can be assigned to respective instruments, and stacking of tokens is used to indicate simultaneous notes on one instrument, e.g. the left and right hand parts of a piano score.

In the illustrated embodiment, a structure 12a-d is provided in each field 9 defined to accept one of the tokens 5-7. Correspondingly configured structures on the underside of the tokens 5-7 allow at least some of the token types to be accommodated on only some of the fields. The structures on the underside of the tokens are configured to engage only one or some of the structures 12a-e. For example, tokens representing rhythmic aspects of a music fragment may be provided with structures that engage only corresponding structures 12a,12b in a bottom row 10e of the playing surface 8. Tokens representing introductory melodies, rhythms or a tempo indication may be provided with structures allowing only engagement with corresponding structures 12a,12c in a first column 11a.

To allow a user to avoid placing a token of a certain type at an incompatible position, the structures on the underside of the tokens are shaped differently. In an alternative example, they are configured differently using magnets of different polarity.

In particular in embodiments where tokens 5-7 are intended to be juxtaposed in a third dimension and where such tokens modify each other's properties, it is useful to prevent certain combinations from being made. To this end, the tokens 5-7 are provided with differently configured structures (not shown) defining at least a section of a side part of a token. Tokens are dimensioned such that they can only be juxtaposed in adjacent fields 9 if their structures can engage. The structures of at least some token types are configured to allow engagement with only those of fewer than all other types of token. Of course, in some implementations the shapes of the tokens themselves will be sufficient to configure the side parts of different types of tokens differently, so that no separate structures are used. A side part may be a side surface or a side edge, depending on the embodiment.

Differently configured structures on or of the tokens of different types are a simple and effective way of preventing an attempted placement of a token of a certain type at a position in the spatial ordering violating any of at least one constraint associated with the certain type. This enforces constraints associated with the aspect of a musical fragment represented by that certain type. An attempted placement of a token 5-7 of a certain type at a position in a spatial configuration violating any of at least one constraint associated with the certain type is prevented as a user places the token 5-7 in the spatial configuration, since the structures make it impossible to complete an incorrect placement.

Using structures on the tokens 5-7 and structures in the fields 9 of the playing surface 8, both incorrect combinations of tokens and incorrect absolute placements of tokens can be prevented. It will be appreciated that the constraints represent composition rules. Differently configured structures 12 are suitable for imposing constraints representing universal composition rules. In addition, there may be further composition rules that are only valid for certain styles of compositions. These can also be translated into constraints associated with tokens 5-7 of a certain type and determining at which positions in a spatial configuration they may be placed, as will be explained further below.

The game board 2 includes sensors 13 positioned within the game board and arranged to determine the types of tokens placed on a field present over the respective sensor 13. The sensor 13 may be a type of connector for mating with a corresponding connector on a token placed on the field, so as to interrogate the token as to its type and that of any token stacked on top of it. In another embodiment, the tokens 5-7 are provided with Radio-Frequency Identification tags, and the sensors 13 comprise transceivers for reading out type information from the tags. Other wireless or wired variants are conceivable, such as those using near field communication.

An interface 14 in the game board 2 allows the respective locations and types of the tokens 5-7 assembled in a spatial configuration on the playing surface 8 to be communicated to the control unit 3 via a corresponding interface 15 in the control unit 3. The latter comprises a processor 16, programmed by means of instructions stored in a memory unit 17. The processor 16 has access to a further memory unit 18 containing data representative of composition rules as well as a database relating token types to aspects of musical fragments. The processor 16 is also able to control the visual display unit 4, as well as an audio output stage 19 for driving a speaker system 20.

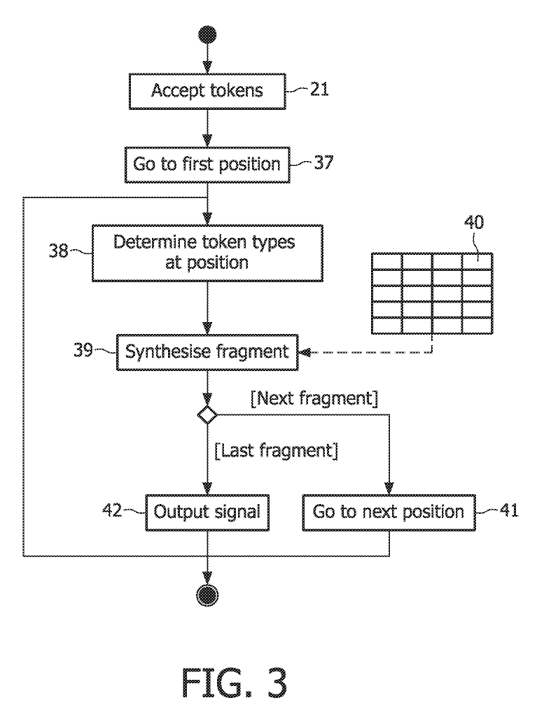

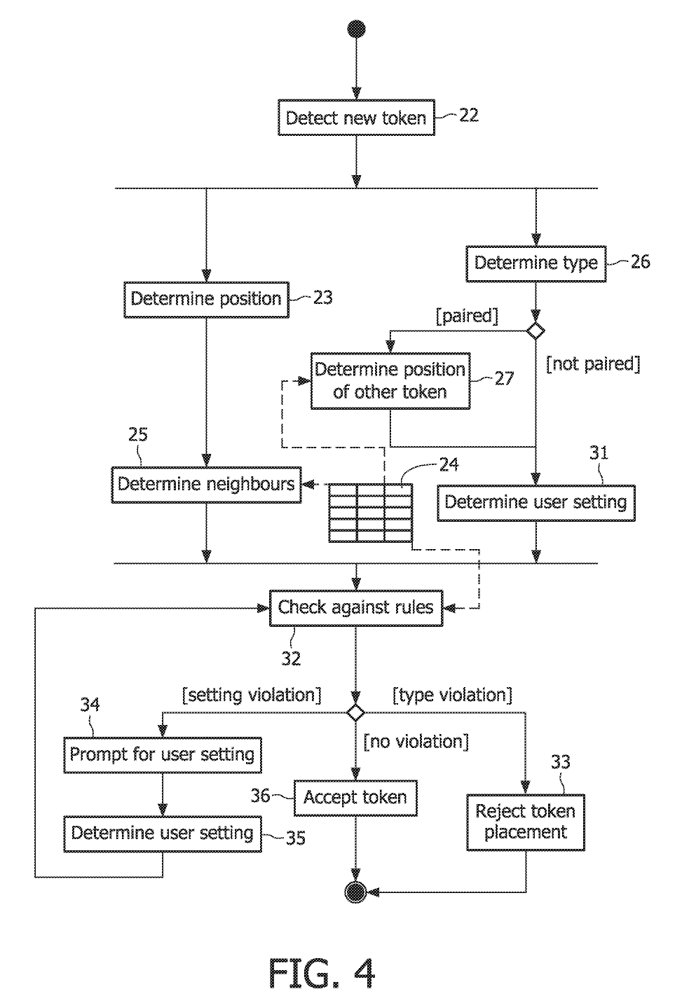

Turning to FIG. 3, a method of generating a musical composition, carried out by the first musical composition system 1, includes accepting the tokens 5-7 placed on the playing surface 8 (step 21). An implementation of this step 21 is illustrated in FIG. 4. According to the illustrated embodiment, an attempted placement of each token of a certain type at a position in the spatial ordering violating any of at least one constraint associated with the certain type, is detected as the token concerned is placed in the spatial configuration by a user.

To this end, whenever one of the sensors 13 detects the placement or attempted placement of a new token 5-7 over the field 9 it is monitoring (step 22), this is communicated to the processor 16. The processor 16 determines the position (step 23) of the newly detected token, for example by determining which sensor 13 was triggered. Using, for example, a database 24 maintained in the further memory unit 18 including for each detected token 5-7 its location and type, the processor 16 determines (step 25) the types and locations of tokens 5-7 placed under the newly detected token and/or in the same column and/or in the same row and the columns immediately preceding or following the column of the newly detected token 5-7.

The processor 16 also determines (step 26) the basic type of the newly detected token 5-7, using data received from one of the sensors 13.

In the illustrated embodiment, pairs of tokens 5-7 of associated types are provided, visibly distinct from tokens of other types. Together the tokens of a pair represent an aspect of a fragment of a musical composition. A first represents the commencement of the fragment and the second represents the termination of the fragment. At a later stage, to be discussed in more detail below, the column distance between the first and second token of a pair is translated to an interval of time, and the translation of the types of the paired tokens is extended to the interval of time when generating a signal for audible reproduction of the musical composition. At the stage of accepting or rejecting tokens 5-7, the position of the other token of a pair is determined (step 27), if, in the preceding step 26, the token is determined to be of a type denoting a first token of a pair.

As illustrated in FIG. 1, a token 7 of a third type includes a display 28 and two keys 29,30. The keys 29,30 enable a user to modify the aspect of a musical fragment that the token 7 of the third type represents, for example in response to a prompt message provided on the visual display unit 4 of the control unit 3. As an example, the keys 29,30 can be used to let a melody and/or chord fragment have an adjustable transposition number, displayed on the display 28. Another application is to have the token 7 represent a tempo or a deviation from a default tempo, e.g. defined by a number of beats per minute shown on the display 28. In this application, the token 7 is preferably one of a pair, to indicate that the tempo is valid for the entire interval spanned by the pair. Another application would be to have the token 7 represent a volume, with the display indicating a volume level on a particular scale. Again, the token 7 is then preferably one of a pair. The current settings are determined (step 31) prior to checking (step 32) that the location and type of the newly detected token 7 do not violate any of a set of rules stored in the further memory unit 18.

In case any of the constraints are violated to an extent that this cannot be remedied, the token's placement is rejected (step 33). In one embodiment, this means that a message is displayed on the visual display unit 4. In another embodiment, a light (not shown) on the token 5-7 will be activated.

In the case of the token 7 of the third type, if only the settings violate a constraint, then the user is prompted (step 34) to adjust the user settings using the keys 29,30 on the token 7. Then, the adjusted user settings are determined (step 35), and the step 32 of checking the token's type and location against pre-determined constraints is repeated.

If none of the constraints are violated, then the token is accepted (step 36). In an embodiment, a visible confirmation of this may be provided on the visual display unit 4.

Returning to the overall outline provided in FIG. 3, once the step of accepting the tokens 5-7 has been completed, the generation of a musical composition continues. Completion of the first step 21 can be indicated by a user input. Alternatively, it can be inferred from the absence of placements of new tokens over more than a certain time interval.

The control unit 3 will first examine (step 37) the tokens in the first column 11a, determining their types and row position (step 38). For at least one type of token, only the types of tokens placed immediately adjacent at least one other token are translated into respective aspects of at least a fragment of a musical composition. This concerns primarily tokens representing aspects of a fragment that modify other aspects. For example, a token representing dynamics of performance may not be considered unless stacked on top of a token representing an instrument or voice.

In a next step 39, the types of the tokens at the current position, together with their settings in the case of a token 7 of the third type, are translated into respective aspects of the current fragment of the musical composition. To this end, the processor 16 uses a database 40 stored in the further memory unit 18. The translation of certain types of tokens includes selecting one of a plurality of aspects in dependence also on the location of a token in the spatial configuration of the assembly of tokens on the playing surface 8. Account may be taken of either or both of the absolute and relative location of the token. That is to say that one type of token may represent a different aspect depending on which row 10 it has been placed in. Obviously, the type of a neighbouring token may influence an aspect represented by a token of a certain type.

The control unit 3 moves on (step 42) to each next column 11 in turn, to analyse the types and locations of tokens 5-7 placed in that column 11, repeating the steps 38,39 discussed above for that column 11.

With each execution of the step 39 of synthesising a fragment of the musical composition, a corresponding section of a signal is generated. The complete signal representing a synthesis of the respective aspects of fragments of the musical composition in accordance with the temporal ordering is provided in a final step 42. This signal, for example in a MIDI (Musical Instrument Digital Interface) format, is suitable for audible reproduction, for example by means of a built-in DLS midi synthesiser or an FM synthesiser, on the speaker system 20. Alternatively or additionally, an interface to a personal computer may allow the saving or playing of audio data on the personal computer.

The method shown in FIGS. 3 and 4 is suitable for allowing a user to compose any desired piece of music conforming to pre-set rules of composition. A variant of the method including generating configuration data encoding the locations and types of at least one of the tokens placed in a spatial configuration by the user(s), comparing the data with at least one set of reference data, and providing on an output device an indication of the presence or absence of a match between the spatial configuration and at least a part of a configuration represented by the set(s) of reference data. This variant can be used to test whether a user is able to re-compose a set piece of music. In one embodiment, the step 32 of checking a new token's type and position against pre-set rules includes generating configuration data encoding the location and type of the token last placed on the playing surface 8 by the user(s), comparing the data with at least one set of reference data, representing the target composition, and then proceeding to one of the next steps 33,34,36. In another embodiment, an entire completed assembly of tokens is analysed.

In another application of the first musical composition system 1, placements of a token of a certain type at a position in the spatial ordering violating any of at least one constraint associated with the certain type are detected, but not prevented. Upon completion of the assembly of tokens, a score is computed, representing the degree to which the constraints are violated by the tokens comprised in the assembly. This application can be used to teach a user to compose in a certain style, for example.

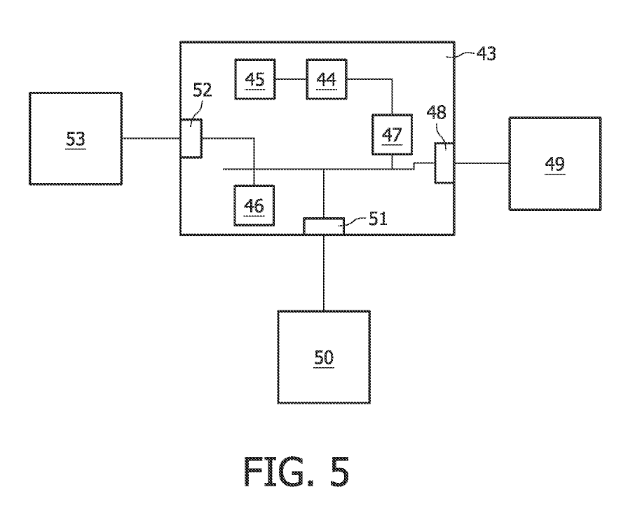

FIG. 5 shows a general-purpose computer 43, e.g. a Personal Computer or workstation, as an example of a second musical composition system. In a known manner, the general-purpose computer 43 comprises a central processing unit 44, main memory 45 and a data storage device 46. A controller 47 directs communication between the central processing unit 44 and other devices. An interface 48 to a visual display unit 49 allows general-purpose computer 43 to implement a method as outlined in FIGS. 3 and 4. In this implementation, representations of at least the tokens 5-7, but in most embodiments also of the playing surface 8, are generated on the visual display unit 49. An input device 50 is provided to allow a user to manipulate the representations of tokens 5-7 by means of suitable input signals received by the general-purpose computer 43 through an interface 51. In the final step 42 of the method of generating a musical composition, a signal representing the synthesis of respective aspects of fragments of a musical composition is generated. It is delivered through an audio interface 52 for reproduction on a speaker system 53.

The second musical composition system operates in substantially the same way as the first musical composition system, except that the sensors 13 are not required. Instead, software objects, each an instantiation of a token of a particular type, are interrogated to determine their properties in one embodiment. In another embodiment, a database of tokens placed by the user in a spatial configuration is maintained in the data storage device 46.

It should be noted that the above-mentioned embodiments illustrate rather than limit the invention, and that those skilled in the art will be able to design many alternative embodiments without departing from the scope of the appended claims. In the claims, any reference signs placed between parentheses shall not be construed as limiting the claim. Use of the verb “comprise” and its conjugations does not exclude the presence of elements or steps other than those stated in a claim. The article “a” or “an” preceding an element does not exclude the presence of a plurality of such elements. The invention may be implemented by means of hardware comprising several distinct elements, and by means of a suitably programmed computer. In the device claim enumerating several means, several of these means may be embodied by one and the same item of hardware. The mere fact that certain measures are recited in mutually different dependent claims does not indicate that a combination of these measures cannot be used to advantage.

For example, a spatial configuration could be the amalgamation of the sub-assemblies of tokens, placed on different game boards 2, connected to control units in communication with each other. In that case, the users of the several game boards 2 could collaborate over a distance to compose a single piece of music. Such a system allowing for collaboration is even easier to implement using several embodiments of the second composition system. In particular the second composition system may dispense with a game board on which tokens are to be placed, but may instead use only representations of interlocking blocks or other types of tangible objects. Tokens of different dimensions may be used to represent aspects of fragments of corresponding different lengths, i.e. durations.

1. Method of controlling a generation of a musical composition, including
determining respective locations and types of an assembly of tokens (5-7) placed in a spatial configuration by the user(s), the tokens (5-7) being of visibly distinct types, each representing aspects of at least a fragment of a musical composition, wherein the tokens (5-7) are configured for placement by at least one user in a spatial configuration;
translating a spatial ordering of the tokens (5-7) in the spatial configuration into a temporal ordering;
translating the types of the tokens (5-7) into respective aspects of at least a fragment of a musical composition using a database (40) relating token types to aspects of at least a fragment of a musical composition;
generating at least one signal representing a synthesis of the respective aspects of fragments of a musical composition in accordance with the temporal ordering, the signals being suitable for audible reproduction, and
detecting or preventing at least an attempted placement of a token of a certain type at a position in the spatial ordering violating any of at least one constraint associated with the certain type.

2. Method according to claim 1, including detecting or preventing at least an attempted placement of each token (5-7) of a certain type at a position in the spatial ordering violating any of at least one constraint associated with the certain type, as it is placed in the spatial configuration by the user(s).

3. Method according to claim 1, wherein the tokens are configured to be placed in two dimensions and further configured to be placed such as to overlap in the two dimensions, including determining the tokens' respective positions in one of the two dimensions to translate the spatial ordering into the temporal ordering.

4. Method according to claim 1, wherein translating the types of tokens into respective aspects of at least a fragment of a musical composition includes selecting one of a plurality of aspects in dependence also on the location of a token in the spatial configuration.

5. Method according to claim 1, wherein translating the types of tokens into respective aspects of at least a fragment of a musical composition includes selecting one of a plurality of aspects in dependence also on a user input, for example prompted to be provided on determination of the token's type and position.

6. Method according to claim 1, wherein, for at least one type of token, only the types of tokens placed immediately adjacent at least one other token are translated into respective aspects of at least a fragment of a musical composition.

7. Method according to claim 1, including providing pairs of tokens of associated types, visibly distinct from tokens of other types and both representing an aspect of a fragment of a musical composition, wherein, at least upon placement by the user(s), a first represents a commencement of the fragment and a second represents a termination of a fragment, translating a distance between the first and second token of a pair in the spatial configuration to an interval of time and extending a translation of the type(s) of the pair of tokens into an aspect of a fragment of a musical composition to the interval of time when generating the signal(s).

8. Method according to claim 1, including generating configuration data encoding the locations and types of at least one of the tokens placed in a spatial configuration by the user(s), comparing the data with at least one set of reference data, and providing on an output device an indication of the presence or absence of a match between the spatial configuration and at least a part of a configuration represented by the set(s) of reference data.

9. Musical composition system, including
a system for determining respective locations and types of an assembly of tokens (5-7) placed in a spatial configuration by the user(s), the tokens (5-7) being of visibly distinct types, each representing aspects of at least a fragment of a musical composition, wherein the tokens are configured for placement by at least one user in a spatial configuration;
a system (13-16;44-46) for translating a spatial ordering of the tokens (5-7) in the spatial configuration into a temporal ordering;
a system (13,18,40;44-46) for translating the types of the tokens (5-7) into respective aspects of at least a fragment of a musical composition; and
a system (13,18-20;44-46) for generating at least one signal representing a synthesis of the respective aspects of fragments of a musical composition in accordance with the temporal ordering, the signals being suitable for audible reproduction,
the system being arranged to detect or prevent at least an attempted placement of a token of a certain type at a position in the spatial ordering violating any of at least one constraint associated with the certain type.

10. System according to claim 9, wherein the tokens (5-7) are configured to allow engagement of at least a section of a side part of a token of a certain type with at least a section of a side part of only a token of any one of fewer than all other types.

11. System according to claim 9, including an at least one-dimensional playing space, configured to accommodate tokens to be placed in the spatial configuration, wherein the system for determining the respective locations of the assembly of tokens is arranged to determine co-ordinates of the tokens relative to the at least one-dimensional playing space.

12. System according to claim 11, wherein the playing space includes one of a plurality of differently configured structures (12a-12e) at each of a plurality of positions (9) defined to accept a token (5-7) and wherein the tokens (5-7) are configured only to allow engagement with fewer than all of the differently configured structures (12a-12e).

13. System according to claim 9, wherein the tokens (5-7) comprise respective tangible objects.

14. System according to claim 9, including a computer for generating representations of at least the tokens placed in the spatial configuration on a visual display unit.

15. System according to claim 9, configured to carry out a method of controlling a generation of a musical composition, including
determining respective locations and types of an assembly of tokens placed in a spatial configuration by the user(s), the tokens being of visibly distinct types, each representing aspects of at least a fragment of a musical composition, wherein the tokens are configured for placement by at least one user in a spatial configuration;
translating a spatial ordering of the tokens in the spatial configuration into a temporal ordering;
translating the types of the tokens into respective aspects of at least a fragment of a musical composition using a database relating token types to aspects of at least a fragment of a musical composition; generating at least one signal representing a synthesis of the respective aspects of fragments of a musical composition in accordance with the temporal ordering, the signals being suitable for audible reproduction, and
detecting or preventing at least an attempted placement of a token of a certain type at a position in the spatial ordering violating any of at least one constraint associated with the certain type.

16. A Computer program incorporated in a machine readable medium including a set of instructions, capable of causing a system having information processing capabilities and including a plurality of tokens of visibly distinct types to perform a method according to claim 1.

17. A method of controlling a generation of a musical composition, including:
determining respective locations and types of an assembly of tokens placed in a spatial configuration by at least one user, the tokens being of visibly distinct types, each representing aspects of at least a fragment of a musical composition, wherein the tokens are configured for placement by said at least one user in the spatial configuration in at least one row and/or at least one column and/or at least one stack of one atop the other;
translating a spatial ordering of the tokens in the spatial configuration into a temporal ordering;
in dependence on the location of a token in the spatial configuration of the assembly of tokens, translating the types of the tokens into respective aspects of at least a fragment of a musical composition using a database relating token types to aspects of at least a fragment of a musical composition;
generating at least one signal representing a synthesis of the respective aspects of fragments of a musical composition in accordance with the temporal ordering, the signals being suitable for audible reproduction; and
detecting or preventing at least an attempted placement of a token of a certain type at a position in the spatial ordering violating any of at least one constraint associated with the certain type.

18. A musical composition system, comprising:
a system for determining respective locations and types of an assembly of tokens placed in a spatial configuration by at least one user, the tokens being of visibly distinct types, each representing aspects of at least a fragment of a musical composition, wherein the tokens are configured for placement by said at least one user in the spatial configuration in at least one row and/or at least one column and/or at least one stack of one atop the other;
a system for translating a spatial ordering of the tokens in the spatial configuration into a temporal ordering;
a system for translating the types of the tokens into respective aspects of at least a fragment of a musical composition in dependence on the location of a token in the spatial configuration of the assembly of tokens; and
a system for generating at least one signal representing a synthesis of the respective aspects of fragments of a musical composition in accordance with the temporal ordering, the signals being suitable for audible reproduction,
the system being arranged to detect or prevent at least an attempted placement of a token of a certain type at a position in the spatial ordering violating any of at least one constraint associated with the certain type.
